(19) United States
(12) Patent Application Publication
(10) Pub. No.: US 2016/0040458 A1
(43) Pub. Date: Feb. 11, 2016

(54) DUST COLLECTOR WITH EXPLOSION RESISTANT DOOR

(71) Applicant: CAMFIL USA, INC, Jonesboro, AR (US)

(72) Inventors: Michael C. WALTERS, Jonesboro, AR (US); Anthony John SUPINE, Jonesboro, AR (US)

(21) Appl. No.: 14/453,521

(22) Filed: Aug. 6, 2014

(51) Int. Cl. E05C 3/02; B01D 46/00

(52) U.S. Cl. CPC E05C 3/02; B01D 46/0093

(57) ABSTRACT

A dust collector is provided. The dust collector includes a housing, a door, and a locking assembly. The locking assembly includes a lockrod rotatably coupled to the door. The lockrod has a first end extending beyond a first side of the door and second end extending beyond a second side of the door. The locking assembly also includes a cam fixed to each end of the lockrod. The locking assembly further includes a keeper assembly to interface with each cam. The keeper assembly includes a keeper having a key and a keeper pin. A longitudinal axis of the keeper pin is offset relative to a longitudinal axis of the key. The keeper assembly further includes a keyway to accommodate the key. The keyway is fixed to the housing proximate one of the cams.

### FIELD

Embodiments of the disclosure generally relate to the field of locking doors for industrial processes, and more particularly, to doors used on dust collectors.

### BACKGROUND

Many common dusts used or generated by industrial processes are combustible and thus present a hazard when such dust is present in high enough concentrations. Dust collector systems can be used to remove this dust to prevent fires and explosions from occurring due to accumulation of the combustible dust. Dust explosions can occur when a high concentration of combustible dust, an oxidant, and an ignition source are present in a confined space. Dust collectors seek to reduce the risk of explosion by removing high concentrations of dust from the surrounding atmosphere. However, in the process of doing so most of the conditions for a dust explosion are created inside the dust collector (i.e., high concentration of combustible dust and an oxidant in a confined space). To prevent the final condition, the ignition source, from occurring, dust collectors are generally equipped with components, such as spark arrestors. Nevertheless, explosions still can occur inside dust collectors.

In order to prevent an explosion inside a dust collector from causing a larger explosion or fire outside of the dust collector, the enclosure housing the dust collector must be strong enough to contain any explosion occurring within the dust collector. Like any other machine, dust collectors require maintenance, and access to perform the maintenance is provided through access doors. Consequently, any access doors on the dust collector must also be strong enough and sealed with enough pressure to contain any explosion from within the dust collector.

Dust collector doors are typically closed and locked through a manual process, which often results in a struggle for the operator attempting to close and lock the dust collector door with sufficient pressure to contain an explosion. Furthermore, various parts of the dust collector door and locking assembly eventually expand, contract, or shift resulting in either a door that is not sealed with enough pressure to contain an explosion from within the dust collector or a door that is even more difficult to properly close and lock.

Therefore, there is a need for an improved dust collector door and locking assembly.

### SUMMARY

Embodiments of the disclosure generally relate to the field of locking doors for industrial processes, and more particularly, to doors used on dust collectors. Although the following is mainly described in relation to a door on a dust collector, a dust collector is only one example of a structure that can benefit from the embodiments described herein.

In one embodiment, a dust collector is provided. The dust collector includes a housing, a door, and a locking assembly. The locking assembly includes a lockrod rotatably coupled to the door. The lockrod has a first end extending beyond a first side of the door and a second end extending beyond a second side of the door. The locking assembly also includes a cam fixed to each end of the lockrod. The locking assembly further includes a keeper assembly to interface with each cam. The keeper assembly includes a keeper having a key and a keeper pin. A longitudinal axis of the keeper pin is offset relative to a longitudinal axis of the key. The keeper assembly further includes a keyway to accommodate the key. The keyway is fixed to the housing proximate one of the cams.

In another embodiment, a structure with a locking door is provided. The structure includes a housing, a door, and a locking assembly. The locking assembly includes a lockrod rotatably coupled to the door. The lockrod has a first end extending beyond a first side of the door and a second end extending beyond a second side of the door. The locking assembly also includes a crescent cam fixed to each end of the lockrod. The lockrod and each crescent cam share a common rotational axis. The locking assembly further includes a keeper assembly having a keeper pin to interface with each cam. The common rotational axis of the lockrod and each cam is substantially collinear with a central axis of the keeper pin when the door is in a locked position.

In another embodiment, a method for adjusting a sealing pressure for a door on a dust collector is provided. The dust collector includes a keeper assembly having a key attached to a keeper pin and a keyway to accommodate the key. The method includes removing the key disposed in a first position from the keyway, placing the key in a second position in the keyway; and closing the door.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic side sectional view of an exemplary dust collector that may be used to practice various embodiments.

FIG. 2A is a partial top sectional view of a keeper assembly, according to one embodiment.

FIG. 2B is a partial sectional view of a locking assembly, according to one embodiment.

FIG. 2C is a side sectional view of a keeper, according to one embodiment.

FIG. 2D is a top sectional view of a cam and a keeper according to one embodiment.

FIG. 2E is a top sectional view of a cam and a keeper according to one embodiment.

FIG. 3 is a top view illustrating multiple positions of a keeper relative to a housing surface, according to one embodiment.

FIG. 4 is a top view illustrating multiple positions of a keeper relative to a housing surface, according to another embodiment.

FIG. 5 is a process flow diagram, according to one embodiment.

To facilitate understanding, identical reference numerals have been used, where possible, to designate identical elements that are common to the figures. It is contemplated that elements disclosed in one embodiment may be beneficially utilized in other embodiments without specific recitation.

### DETAILED DESCRIPTION

Embodiments of the disclosure generally relate to the field of dust collectors for industrial processes, and more particularly, to explosion resistant doors used on dust collectors. The explosion-resistant doors described include an keeper assembly allowing for different positions of a keeper to adjust a sealing pressure when the door is locked as well as a crescent cam to reduce the force necessary to lock the door.

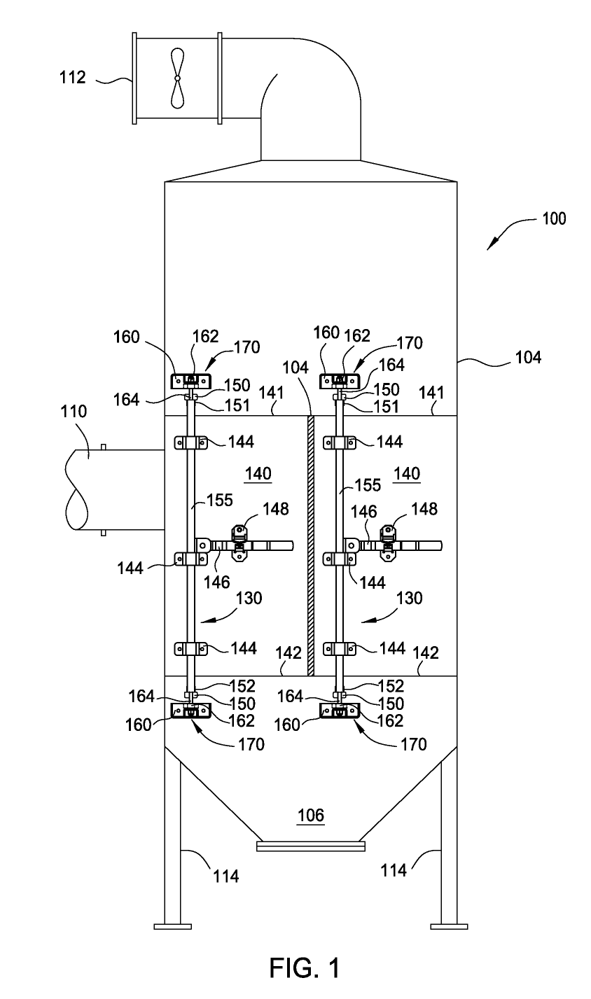

FIG. 1 is a schematic side sectional view of an exemplary dust collector 100 that may be used to practice various embodiments of this disclosure. The dust collector 100 includes a housing 104 forming most of the structure of the dust collector 100 and legs 114 supporting the housing 104. The dust collector 100 further includes an intake 110 and an exhaust 112. During operation, the dust collector 100 uses suction to draw in dust-containing air through the intake 110 and then through filters (not shown) in the interior of the dust collector 100. Then clean air is expelled through the exhaust 112. Dust removed by the filters can be collected below a hopper 106 attached to the housing 104.

The dust collector 100 further includes one or more doors 140 and a locking assembly 130 for each door 140. The locking assemblies 130 are used to lock the doors 140 with sufficient pressure to contain an explosion. The doors 140, the housing 104, and many of the different components in the locking assembly 130 can be fabricated from steel or other suitable materials. Each locking assembly 130 includes a lockrod 155 rotatably coupled to each door 140. The lockrod 155 can be a long cylindrical shaft or other bar-shaped member. The locking assembly 130 can include support brackets 144 that may include bearings to provide axial support for the lockrods 155 while allowing rotation. Each lockrod 155 has a first end 151 extending beyond a first side 141 of the door 140 and a second end 152 extending beyond a second side 142 of the door 140. Each locking assembly 130 further includes a cam 150 fixed to each end of the lockrod 155. A handle 146 is attached to each lockrod 155 and can be used to rotate the lockrod 155 between positions that lock and unlock the door 140. When the lockrod 155 is rotated to a locked position, the handle 146 can be latched in a retaining bracket 148 to prevent the lockrod from rotating.

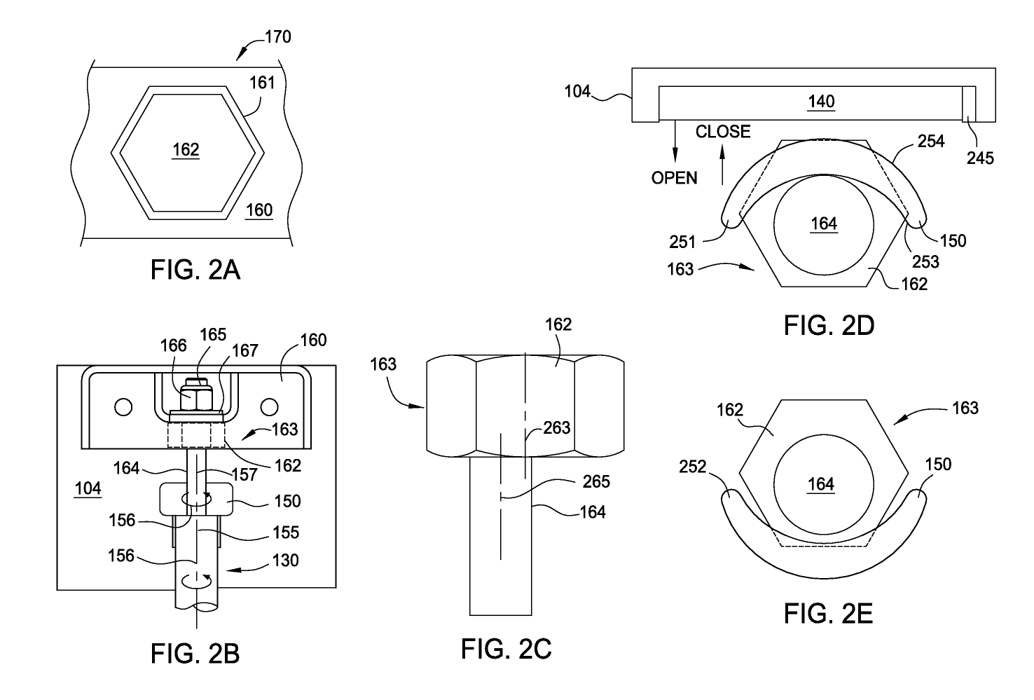

Each locking assembly 130 further includes a keeper assembly 170 to interface with each cam 150. Each keeper assembly 170 includes a keeper 163 (see FIG. 2B) and a keeper bracket 160 fixed to the housing 104 proximate to one of the cams 150. Each keeper bracket 160 is used to support the keeper 163, which includes a keeper pin 164 and a key 162. The cams 150 can engage and disengage the respective keeper pins 164 when the lockrod 155 is rotated to lock and unlock the door 140. The position of the key 162 can be adjusted, as will be described in further detail, to change the position of the keeper pin 164. Changing the position of the keeper pin 164 allows the sealing pressure (i.e., force) of the door 140 to be adjusted as cam 150 engages the keeper pin 164 in the different positions of the keeper pin 164. Each keeper bracket 160 has a keyway 161 (see FIG. 2A) to accommodate the key 162 in two or more positions of the key 162.

Used herein, a “key” refers to any object whose function is to prevent relative rotational motion between the object and a corresponding “keyway” when the key is placed in the keyway. One example of a key and a keyway is a hexagonal-nut key and a corresponding hexagonal-socket keyway. Another example could include a square-peg key in a square-hole keyway. Another example could include a circular-hole keyway with notches at multiple locations around the keyway circumference along with a circular key having one or more protrusions to fit in the corresponding notches. Numerous other key and keyway combinations can be devised without departing from the basic scope of this disclosure. For the embodiments described herein, the keyway 161 is mounted to or fixed to the housing 104, so the keyway 161 and consequently the key 162 do not move or rotate in any significant amount as the lockrod 155 is rotated to unlock and lock the door 140. Although a keeper bracket 160 is shown mounted to housing 104, a keeper bracket 160 mounted to the housing 104 is only one of numerous ways to mount or fix a keyway 161 in a fixed location, so that the keeper pin 164 can be placed into position.

FIG. 2A is a top sectional view of the keeper assembly 170 showing the keeper bracket 160 that is mounted to the housing 104 above the door 140, according to one embodiment. In this embodiment, the key 162 and the keyway 161 each have hexagonal cross sections. The keyway 161 is a hexagonal hole formed in the keeper bracket 160. The key 162 is a corresponding hexagonal structure that fits in the keyway 161. The bottom of the keyway 161 can have another hole to allow the keeper pin 164 to extend below or above the keeper bracket 160 depending on location of the keeper bracket (i.e., top or bottom of the door 140). In this embodiment, the keyway 161 can accommodate the key 162 in one of six different angular positions of the key 162. As described below, changing the position of the key 162 in the keyway 161 causes the position of the keeper pin 164 to change.

Other polygon-shaped keys and keyways can also be used. For example, the key and keyway can each have cross sections in a shape of a polygon having “n” sides, where “n” is an integer between 3 and 20. Polygon-shaped keys and keyways with higher number of sides allow for more positions of the key and consequently, more positions for the keeper pin allowing finer adjustments for the sealing pressure of the door 140 when the door 140 is locked.

FIG. 2B is a partial sectional view of the locking assembly 130, according to one embodiment. The keeper 163 is shown with the key 162 placed in the keyway 161 and the keeper pin 164 extending below the keeper bracket 160, so this illustrates a keeper above the door 140. The keeper 163 could further include a distal member 165, such as a threaded connection, that can be used to secure the keeper 163 to the keeper bracket 160 preventing any significant movement of the keeper pin 164 when the cam 150 engages and disengages the keeper pin 164. For example, a washer 167 and a nut 166 can be used to mount the keeper 163 to the keeper bracket 160.

The cam 150 is shown in the locked position in FIG. 2B with the cam 150 being between the keeper pin 164 and the housing 104. The lockrod 155 and both cams 150 (top and bottom) can share a common rotational axis 156. Furthermore, when the door 140 is locked, the common rotational axis 156 of the lockrod 155 and each cam 150 is also substantially collinear with a central axis 157 of each keeper pin 164 (top and bottom), which can substantially eliminate a cause of torsion that has to be resisted by the cams 150 and also the handle 146 during an explosion. Used herein, substantially collinear is defined as within half of an inch, for example within an eighth of an inch. If a keeper pin has a central axis significantly spaced apart from the rotational axis from the lockrod, then an explosive force from within the dust collector housing can cause the cam or handle to fail or break off due to the moment arm created by the offset between the keeper pin axis and the rotational axis of the lockrod. Failure of the cam or the handle can result in an increased risk of a larger explosion or fire outside of the dust collector as well as increased equipment costs. Moreover, in some embodiments, a point of contact between the cam 150 and the keeper pin 164 and a point on the rotational axis 156 of the lockrod 155 may substantially align on a common radius relative to an axis of rotation of the door 140 (e.g., the axis through the hinges about which the door rotates), thus serving as another way to substantially eliminate torsional forces on the lockrod 155 and handle 146 in the event of an explosion within the dust collector 100.

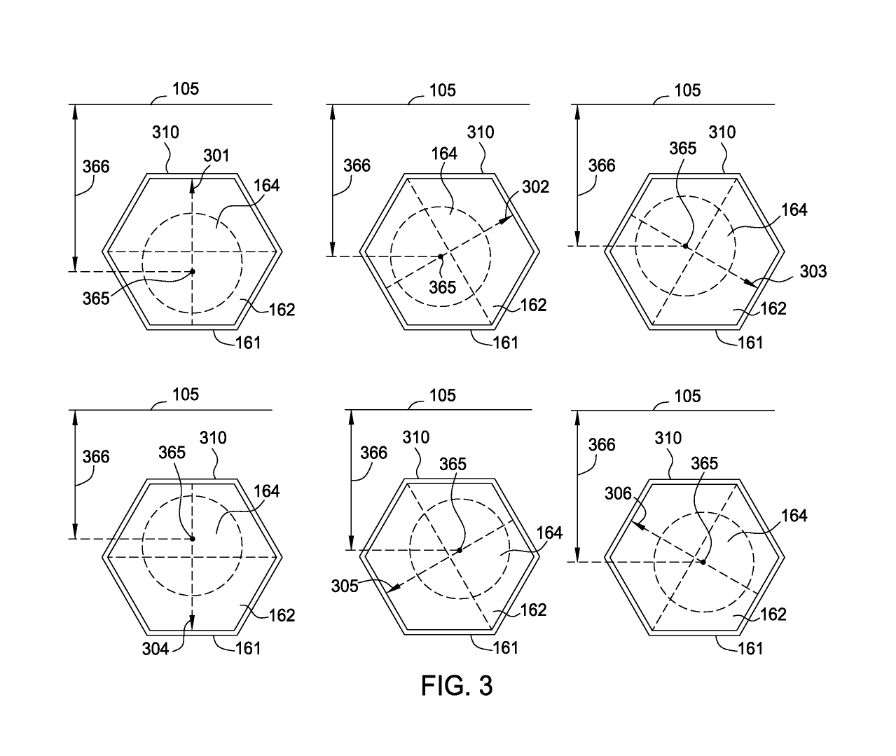

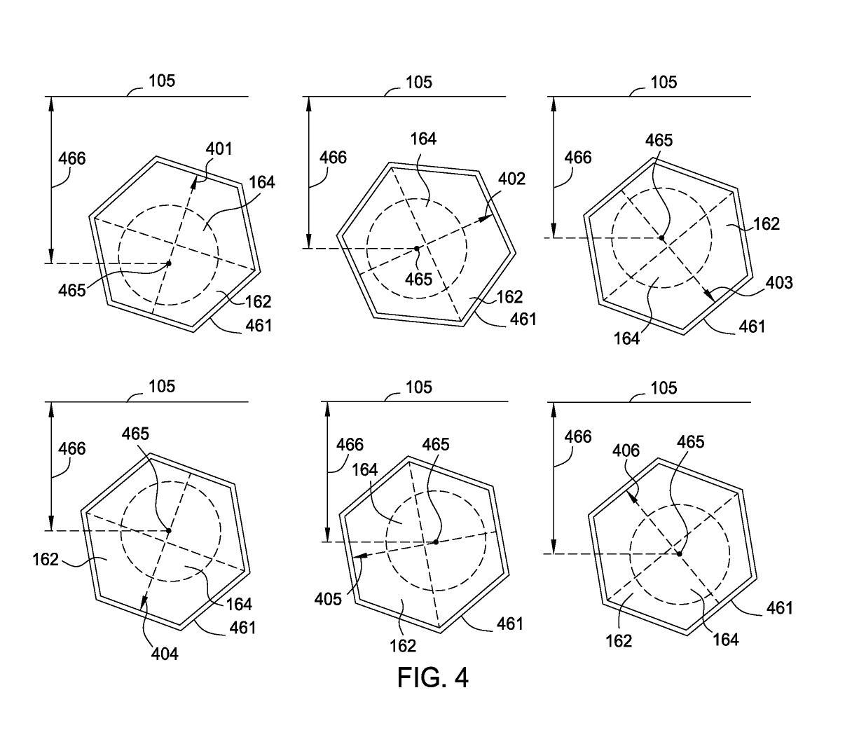

FIG. 2C is a partial side sectional view of the keeper 163, according to one embodiment. FIG. 2C illustrates how a longitudinal axis 265 of the keeper pin 164 is offset from a longitudinal axis 263 of the key 162 allowing the keeper pin 164 to change locations when the key 162 is placed into different positions in the keyway 161. Offsetting the longitudinal axis 265 from the longitudinal axis 263 makes the center of the keeper pin eccentric with respect to the center of the key 162. FIGS. 3 and 4 provide additional detail illustrating how the keeper pin 164 changes locations when the key 162 is placed into different positions in the keyway 161.

FIGS. 2D and 2E are top sectional views of the cam 150 and the keeper 163, which are below the door 140 in these top views, in a locked position 251 (FIG. 2D) and an unlocked position 252 (FIG. 2E), according to one embodiment. A block diagram of the location of the door 140, the housing 104, and a set of hinges 245 are shown in FIG. 2D to illustrate the relative position of the door 140 to the cam 150 and keeper 163 when the cam 150 and the door 140 are in the locked position 251. Open and close arrows are also shown to clearly illustrate the direction that the door 140 swings on the hinges 245 to open and close relative to the housing 104. Although the lockrod 155 is attached to the cam 150, the lockrod 155 is not shown in FIGS. 2D and 2E to more clearly illustrate the interaction of the cam 150 with the keeper pin 164 as the door 140 is unlocked and locked.

When the lockrod 155 is rotated to the locked position 251, the cam 150 engages the keeper pin 164. The cam 150 has a crescent shape that is designed to interface with the keeper pin 164, which has a cylindrical shape. The crescent shape of the cam 150 allows the cam 150 to act like a wedge between the door 140 and the keeper pin 164. The crescent shape of the cam 150 can create a mechanical advantage between about 10:1 to about 100:1, for example about 50:1. This mechanical advantage eases the closure and locking of the doors 140 that must be sealed with enough pressure to contain an explosion from within the dust collector 100. The crescent shape of the cam 150 can include an inner arc 253 and an outer arc 254. In some embodiments, the inner arc 253 and/or the outer arc 254 could each be defined by a separate radius extending from a center point that is the same as a center point of a circular cross section of the lockrod 155. Having one or more of the arcs 253, 254 symmetrically arranged around a center point that coincides with a center point of a cross section of the lockrod 155 further prevents any substantial twisting of the cams 150 and lockrod 155 during an explosion. In other embodiments, the arcs 243, 244 can be defined by radii that extend from different center points that do not coincide with a center point of the lockrod 155. When the lockrod 155 is rotated to the unlocked position 252, the cam 150 disengages from the keeper pin 164 and the door 140 can be freely swung open away from the housing 104.

FIG. 3 is a top view from above the door 140 illustrating multiple positions of the key 162 in the keyway 161 as well as the locations of the keeper pin 164 relative to a front surface 105 of the housing 104, according to one embodiment. The front surface 105 of the housing 104 is substantially parallel or coplanar with the outer surface of the doors 140 when the doors 140 are locked. In this embodiment, at least at least one side 310 of a cross section of the keyway 161 is substantially parallel to the front surface 105 of the housing 104. FIG. 3 illustrates the key 162 in six different positions 301-306 in the keyway 161, which has a fixed position. As shown, the location of the center 365 of the keeper pin 164 changes for each position 301-306 of the key 162. A distance 366 between the center 365 of the keeper pin 164 and the front surface 105 of the housing 104 is different for four of the positions 301-304. Thus, the distance 366 between the center 365 of the keeper pin 164 and the front surface 105 is different for at least half of the six positions of the key 162. The distance 366 is the same for positions 302 and 306, and is also the same for positions 303 and 305. Positions 306 and 305 do differ from respective positions 302 and 303 in along directions parallel to side 310, so positions 305, 306 can be useful to counteract any shifting that occurs in those directions.

FIG. 4 is a top view from above the door 140 illustrating multiple positions of the key 162 in a keyway 461 as well as the locations of the keeper pin 164 relative to the front surface 105 of the housing 104, according to another embodiment. The front surface 105 of the housing 104 is substantially parallel or coplanar with the outer surface of the doors 140 when the doors 140 are locked. In this embodiment, the keyway 461 is angled slightly away from the front surface 105, such as an angle of about 20 degrees. In this embodiment, no side of a cross section of the keyway 461 is parallel to the front surface 105 of the housing 104. The angle allows the center 365 of the keeper pin 164 to be at a different distance 466 from the front surface 105 for each position 401-406 of the key 162 in the keyway 461 allowing for finer control of the sealing pressure of the door 140 when the door 140 is locked.

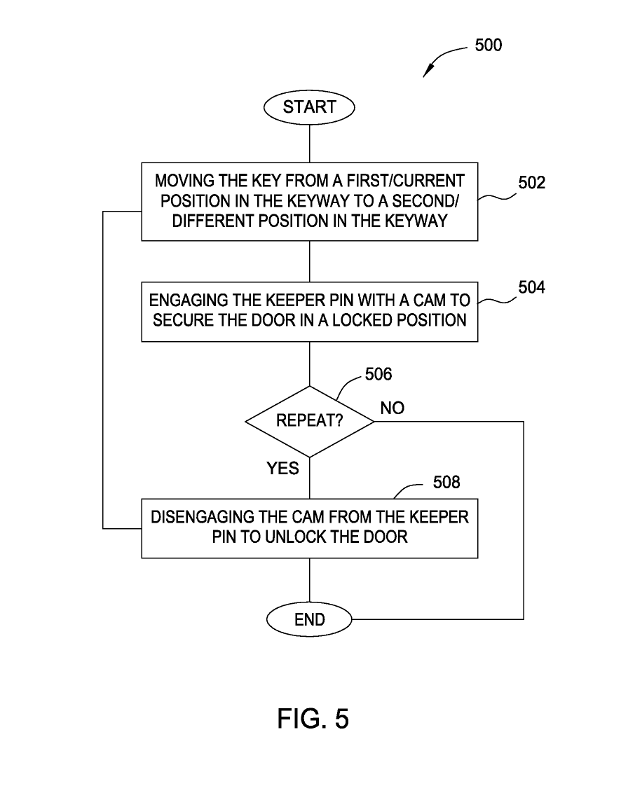

Referring to FIGS. 1-3, and 5 a method 500 is described for adjusting a sealing pressure for the door 140 when the door 140 is locked. Although the method is described in conjunction with reference to the dust collector 100 and locking assembly 130 of FIG. 1, persons skilled in the art would understand that any suitably adapted dust collector and locking assembly configured to perform the method steps, in any order, is within the scope of the implementations disclosed. Method 500 could be executed on dust collector 100.

At block 502, the key 162 is in a first position in the keyway 161, such as position 301, and the key 162 is from the first position to a second position in the keyway 161, such as position 302. Removing the key 162 from the keyway 161 can be done quickly with simple hand tools, such as a wrench.

At block 504, the door 140 door is locked by rotating the lockrod 155 and the cams 150 to the locked position 251, so that the cams 150 engage the keeper pins 164. Moving the position of the key 162 from position 301 to position 302 increases the sealing pressure of the door 140 when the door 140 is locked because the center 365 of the keeper pin 164 is closer to the front surface 105 in position 302 than when the key 162 is in position 301. Because the lockrod 155 and the cams 150 have a common rotational axis that is substantially collinear with the central axis of the keeper pin 164, the changing from position 301 to position 302 results in an increased force on the doors 140 in the direction towards the front surface 105 from the lockrod 155.

At block 506, the operator can decide whether or not the door 140 is locked with an appropriate pressure. If the operator determines there is an appropriate pressure, then method 500 is complete. If the operator determines the pressure is inappropriate, then the operator can unlock the door 140 at block 508 and then repeat blocks 502-506 to continue adjusting the pressure. Using keys and keyways that allow for more than six positions could be used to offer finer control of the sealing pressure of the door.

The embodiments described herein illustrate numerous advantages over existing dust collector doors and locking assemblies. The keeper assembly described enables the position of the keeper pin to be quickly adjusted, which allows the sealing pressure of the locked dust collector door to be finely controlled. Making the adjustment of the sealing pressure of the dust collector door this easy can help to ensure that the dust collector doors are locked and sealed with sufficient pressure to contain any explosion from within the dust collector. Also, changing the position of the keeper pin is done with out any moving parts that could eventually fail or require maintenance. Furthermore, the precision of the pressure control can be increased by using keyways and corresponding keys that allow for more positions of the key and keeper pin.

The crescent shape of the cams provides a mechanical advantage to ease the closing of the dust collector doors. This mechanical advantage can save on the time it takes to close and lock the doors as well as allowing less stress to be placed on components of the locking assembly, such as the handles. Designing the locking assembly, so that the lockrod and cams share a common rotational axis that is substantially collinear with a central axis of the keeper pins when the door is locked provides another advantage. Using this design, the lockrod is essentially or totally not subjected to any torsion when an explosion does occur. Conventional designs having the lockrods offset (i.e., typically to the left or right) from the keeper pins and contact surface of the cams cause the generation of large torsional forces on the lockrod when an explosion does occur within the dust collector, which often can cause the handles to fail and potentially allow the door to open. With the lockrod, cams and keeper pins all sharing a substantially common axis, the force of the explosion does not cause the lockrod to rotate towards or to the unlocked position, thus more effectively retaining the door secured and closed in the locked position. This design will prevent parts from breaking as well as making it more likely that the dust collector door and locking assembly will contain any explosions occurring within the dust collector.

As mentioned above, a dust collector is only one example of a structure that can benefit from the embodiments described herein. Overall, any structure with a locking door that must be sealed with a high pressure or that may be difficult to close and lock can benefit from using the embodiments described above. Such structures include but are not limited to door assemblies for tractor trailers, shipping containers, electrical enclosures, tanks and other storage chambers, as well as other explosion resistant enclosures and various doors for the marine industry.

While the foregoing is directed to embodiments of the present disclosure, other and further embodiments of the disclosure may be devised without departing from the basic scope thereof, and the scope thereof is determined by the claims that follow.

We claim:

1. A dust collector comprising:
a housing;
a door, and
a locking assembly comprising:
a lockrod rotatably coupled to the door, the lockrod having a first end extending beyond a first side of the door and a second end extending beyond a second side of the door;
a cam fixed to each end of the lockrod;
a keeper assembly to interface with each cam, each keeper assembly comprising:
a keeper having a key and a keeper pin, wherein a longitudinal axis of the keeper pin is offset relative to a longitudinal axis of the key; and
a keyway to accommodate the key, the keyway fixed to the housing proximate one of the cams.

2. The dust collector of claim 1, wherein the lockrod is rotatable between a locked position and an unlocked position, wherein each cam engages one of the keeper pins in the locked position and each cam disengages from that keeper pin in the unlocked position.

3. The dust collector of claim 1, wherein the keyway can accommodate the key in two or more angular positions of the key.

4. The dust collector of claim 3, wherein a center of the keeper pin is at a different location for each angular position of the key.

5. The dust collector of claim 1, wherein the keyway can accommodate the key in at least six angular positions of the key.

6. The dust collector of claim 5, wherein a center of the keeper pin is at a different distance from a surface of the housing for at least half of the at least six angular positions of the key.

7. The dust collector of claim 1, wherein the key and keyway each have cross sections in a shape of a polygon having n sides, wherein n is an integer between 3 and 20.

8. The dust collector of claim 7, wherein at least one side of the keyway cross section is parallel to a front surface of the housing, wherein the front surface is substantially parallel to with an outer surface of the door when the door is locked.

9. The dust collector of claim 7, wherein no side of the keyway cross section is parallel to a surface of the housing.

10. The dust collector of claim 1, wherein the key and keyway each have hexagonal cross sections.

11. The dust collector of claim 1, wherein each cam is crescent shaped and each keeper pin is cylindrically shaped.

12. The dust collector of claim 11, wherein the lockrod and each cam share a common rotational axis that is substantially collinear with a central axis of each keeper pin when the door is in a locked position.

13. A structure with a locking door comprising:
a housing;
a door, and
a locking assembly comprising:
a lockrod rotatably coupled to the door, the lockrod having a first end extending beyond a first side of the door and a second end extending beyond a second side of the door;
a crescent cam fixed to each end of the lockrod, wherein the lockrod and each crescent cam share a common rotational axis; and
a keeper assembly having a keeper pin to interface with each cam, wherein the common rotational axis of the lockrod and each cam is substantially collinear with a central axis of each keeper pin when the door is in a locked position.

14. The structure of claim 13, wherein each keeper pin is attached to a key and the keeper assembly can accommodate the key in three or more positions, wherein a distance between a center of the keeper pin and a front surface of the housing is different for at least half of the positions.

15. The structure of claim 14, wherein the distance is different for all of the positions.

16. A method for adjusting a sealing pressure for a door on a dust collector comprising a keeper assembly having a key attached to a keeper pin and a keyway to accommodate the key, the method comprising:
moving the key from a first position in the keyway to a second position in the keyway; and
engaging the keeper pin with a cam to secure the door in a locked position.

17. The method of claim 16, further comprising:
disengaging the cam from the keeper pin to unlock the door;
moving the key from the second position to a third position in the keyway; and
engaging the keeper pin with the cam to secure the door in the locked position.

18. The method of claim 17, wherein a distance between a center of the keeper pin and a surface of the housing is different for all three positions.

19. The method of claim 16, wherein a lockrod coupled to the door is rotated to unlock and lock the door, wherein the cam is fixed to one end of the lockrod, wherein the lockrod and the cam share a common rotational axis that is substantially collinear with a central axis of the keeper pin when the door is locked.

20. The method of claim 16, wherein the cam is crescent shaped and the keeper pin is cylindrically shaped.
